(19) United States
(12) Patent Application Publication
(10) Pub. No.: US 2025/0066232 A1
(43) Pub. Date: Feb. 27, 2025

(54) MULTI-STAGE WASHER INCLUDING A WATER TREATMENT SYSTEM

(71) Applicant: Stolle Machinery Company, LLC, Centennial, CO (US)

(72) Inventor: CHRISTOPHER JAMES FAULKNER, LANCASHIRE (GB)

(73) Assignee: Stolle Machinery Company, LLC, Centennial, CO (US)

(21) Appl. No.: 18/799,028

(22) Filed: Aug. 9, 2024

Related U.S. Application Data
(60) Provisional application No. 63/533,709, filed on Aug. 21, 2023.

(51) Int. Cl. C02F 9/00; B01D 19/00; B01D 21/00; B01D 21/02; B01D 21/24; B08B 3/02; B08B 3/14; C02F 1/00; C02F 1/20; C02F 1/24; C02F 1/40; C02F 1/74; C02F 1/78; C02F 103/34

(52) U.S. Cl. CPC C02F 9/00; B01D 19/0042; B01D 21/0084; B01D 21/02; B01D 21/2438; B01D 21/2494; B08B 3/022; B08B 3/14; B08B 2203/02; C02F 1/004; C02F 1/20; C02F 1/24; C02F 1/40; C02F 1/74; C02F 1/78; C02F 2103/34

(57) ABSTRACT

A multi-stage can washer includes a water treatment system structured to receive contaminated water from the skimming trough corresponding to a last feed tank, to clean the contaminated water, and to provide the cleaned water to a first one of the one or more feed tanks. The water treatment system includes a pressure vessel structured to mix ozone or air with the contaminated water to create gaseous water, a frothing cell structured to cause bubbles to form in the gaseous water to form a froth, to skim off and dispose of the froth, to degas the gaseous water to remove remaining gases, and to output degassed water, and a filtration system structured to receive the degassed water, to filter solid particles from the degassed water to form cleaned water, and to provide the cleaned water to the first feed tank.

### CROSS REFERENCE TO RELATED APPLICATIONS

This application claims priority to U.S. Patent Application Ser. No. 63/533,709, filed Aug. 21, 2023, entitled, Multi-Stage Washer Including A Water Treatment System.

### FIELD OF THE INVENTION

The disclosed concept relates generally to can manufacturing and, more particularly to can washers used in the can manufacturing process.

### BACKGROUND OF THE INVENTION

Metal beverage and food containers (e.g., cans) are mechanically formed using a system of formers and dies. To prevent damage to the products, oils are used to lubricate the surfaces during the forming processes. After the forming process, the oils and other contaminants are washed off the surfaces via a plurality of washing stages in a multi-stage washer. The metal surfaces need to be thoroughly clean and dry before they are sprayed with lacquers and decorated with inks prior to being filled with the food and drink products.

In a multi-stage washer, contaminants have been observed in the water used in the rinsing stage of the washer. These contaminants are not desirable as they can be transferred to the can being washed.

There is room for improvement in can washers.

### SUMMARY OF THE INVENTION

According to an aspect of the disclosed concept, a multi-stage can washer comprises: a conveyor system structured to transport cans through the multi-stage can washer; a piping system structured to transport water to a number of nozzles structured to spray the water onto cans being transported by the conveyor system; one or more feed tanks structured to provide water to the piping system and to collect water sprayed by the nozzles, each feed tank including a skimming trough structured to skim water from a top portion of the feed tank; and a water treatment system structured to receive contaminated water from the skimming trough corresponding to a last one of the one or more feed tanks, to clean the contaminated water, and to provide the cleaned water to a first one of the one or more feed tanks, the water treatment system including: a pressure vessel structured to mix ozone or air with the contaminated water to create gaseous water; a frothing cell structured to cause bubbles to form in the gaseous water to form a froth, to skim off and dispose of the froth, to degas the gaseous water to remove remaining gases, and to output degassed water; and a filtration system structured to receive the degassed water, to filter solid particles from the degassed water to form cleaned water, and to provide the cleaned water to the first one of the one or more feed tanks.

According to another aspect of the disclosed concept, a water treatment system for a multi-stage can washer comprises: a pressure vessel structured to receive contaminated water and to mix ozone or air with the contaminated water to create gaseous water; a frothing cell structured to cause bubbles to form in the gaseous water to form a froth, to skim off and dispose of the froth, to degas the gaseous water to remove remaining gases, and to output degassed water; and a filtration system structured to receive the degassed water, to filter solid particles from the degassed water to form cleaned water, and to output the cleaned water.

According to another aspect of the disclosed concept, a frothing cell for a water treatment system for a multi-stage can washer comprises: a mixing chamber structured to receive gaseous water and to mix one or more chemicals into the gaseous water; a separation chamber having a gradually increasing diameter structured to form bubbles in the gaseous water to form froth, and a separation plate disposed at a top portion of the separation chamber and structured to skim the froth off of the gaseous water; and a degassing chamber structured to remove gasses from the gaseous water and to output degassed water, the degassing chamber including a liquid diverting structure, structured to prevent gasses from reaching a discharge port.

### BRIEF DESCRIPTION OF THE DRAWINGS

A full understanding of the invention can be gained from the following description of the preferred embodiments when read in conjunction with the accompanying drawings in which:

FIG. 1 is a schematic diagram of a multi-stage can washer in accordance with an example embodiment of the disclosed concept; and

FIG. 2 is an elevation view of a frothing cell in accordance with an example embodiment of the disclosed concept.

### DETAILED DESCRIPTION OF THE INVENTION

It will be appreciated that the specific elements illustrated in the figures herein and described in the following specification are simply exemplary embodiments of the disclosed concept, which are provided as non-limiting examples solely for the purpose of illustration. Therefore, specific dimensions, orientations, assembly, number of components used, embodiment configurations and other physical characteristics related to the embodiments disclosed herein are not to be considered limiting on the scope of the disclosed concept.

Directional phrases used herein, such as, for example, clockwise, counterclockwise, left, right, top, bottom, upwards, downwards and derivatives thereof, relate to the orientation of the elements shown in the drawings and are not limiting upon the claims unless expressly recited therein.

As used herein, the singular form of “a,” “an,” and “the” include plural references unless the context clearly dictates otherwise.

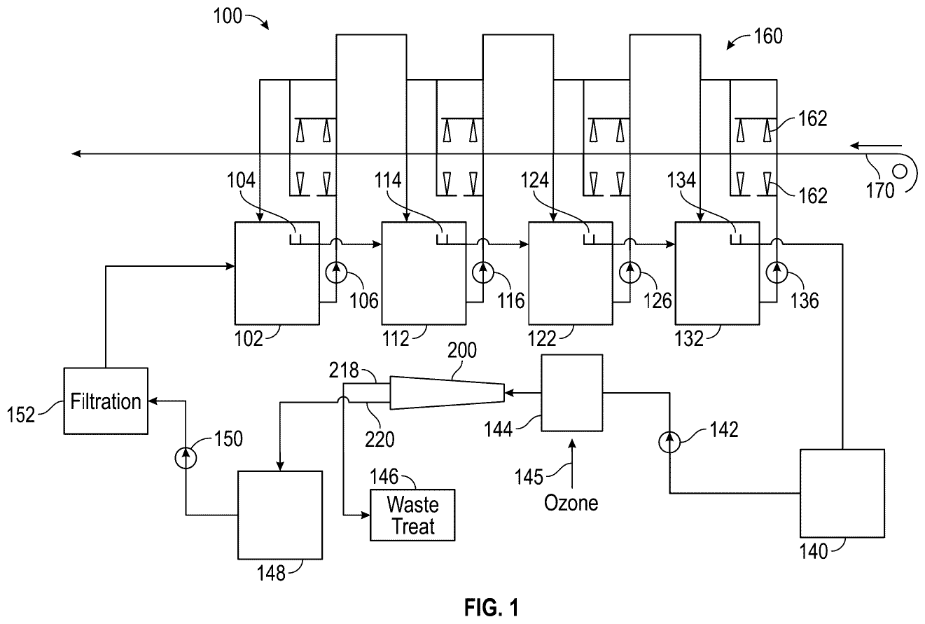

FIG. 1 is a schematic diagram of a portion of a multi-stage can washer 100 in accordance with an example embodiment of the disclosed concept. In particular, FIG. 1 is a schematic diagram of a second rinse stage of the multi-stage can washer 100. The multi-stage can washer 100 may have multiple rinse stages, multiple wash stages, and multiple treatment stages. In some example embodiments, the multi-stage can washer 100 may be a washer/dryer and include one or more drying stages.

Cans are transported through the multi-stage washer 100 by a conveyor system 170. The cans are transported through the multi-stage washer 100 in a direction from right to left as shown in FIG. 1. The second rinse stage includes a closed water loop. Water from four feed tanks 102, 112, 122, 132 is pumped by corresponding feed pumps 106, 116, 126, 136 to a piping system 160. The piping system 160 transports the water to various nozzles 162 disposed above and below the conveyor system 170. The nozzles 162 are structured to spray the water onto the cans passing by on the conveyor system 170.

The multi-stage washer 100 is structured to capture and reuse the water sprayed on the cans. Various drains and pipes may be used to capture the water and transport it back to the feed tanks 102, 112, 122, 132. Capturing and reusing water in the multi-stage washer 100 considerably reduces water usage. However, contaminants, such as oils or other materials rinsed off the cans is introduced into the water in the feed tanks 102, 112, 122, 132. The multi-stage washer 100 includes a system for efficiently treating the water to reduce contaminants.

Contaminants have a natural tendency to float on the surface of the water in the feed tanks 102, 112, 122, 132. To remove such contaminants, each feed tank includes a skimming trough 104, 114, 124, 134. The skimming troughs 104, 114, 124, 134 are structured to drain any material over a predetermined level in the feed tank 102, 112, 122, 132. In more detail, the skimming troughs 104, 114, 124, 134 are located near the tops of the feed tanks 102, 112, 122, 132 such that contaminants that have floated to the tops of the feed tanks 102, 112, 122, 132 will be drained by the skimming troughs 104, 114, 124, 134, while outlets to the piping system 160 are located near the bottom of the feed tanks 102, 112, 122, 132 such that more contaminant free water is fed into the piping system 160 to be used to rinse the cans. The feed tanks 102, 112, 122, 132 are cascaded such that material from the first feed tank 102 is drained into the second feed tank 112 and so on to the fourth feed tank 132, which drains into a water treatment system.

The water skimmed from the fourth feed tank 132 will generally be some of the most contaminated water in the system because it consists of the water skimmed from the first through third feed tanks 102, 112, 122. The water skimmed from the fourth feed tank 132 is transported to a collection tank 140. The collection tank 140 is disposed at the start of a water treatment system. The water collected in the collection tank 140 is pumped by a pump 142 into a pressure vessel 144. Ozone 145 is also pumped into the pressure vessel 144, at pressure, via a diffuser to dissolve the ozone 145 into the water. In this manner, the water is mixed with the ozone 145 in the pressure vessel 144. In some example embodiments, air may be used instead of the ozone 145. The mixing of the water with gas in the pressure vessel 144 creates a gaseous liquid.

The water from the pressure vessel 144 is then transported to a frothing cell 200. The frothing cell 200 is structured to remove contaminants from the water by causing bubbles to form in the water. Contaminants attach to the surface of the bubbles due to electrostatic attraction and the bubbles rise to the top of the water to form a froth. The froth, with the attached contaminants is then skimmed off the surface of the water and can be disposed of by a waste treatment system 146.

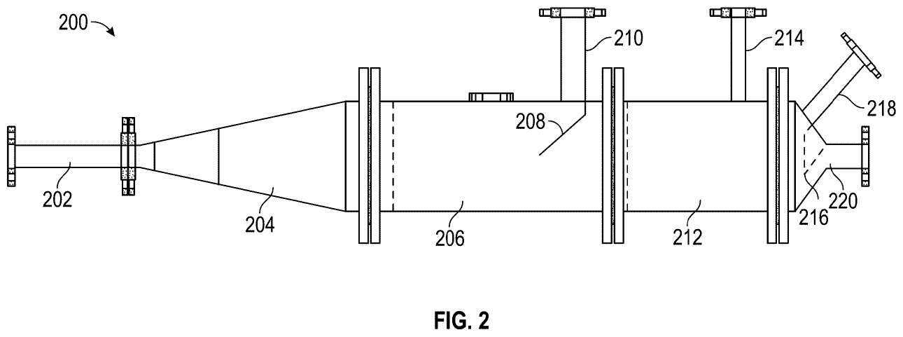

FIG. 2 is an elevation view of a frothing cell 200 in accordance with an example embodiment of the disclosed concept. Water from the pressure vessel 114 enters the frothing cell 200 through a nozzle into a mixing chamber 202. In the mixing chamber 202, one or more chemicals may be mixed into the water to aid the flotation process. The mixing chamber 202 may have a cylindrical shape with a constant diameter. From the mixing chamber 202, the water proceeds to a frothing chamber 204 directly coupled to the mixing chamber 202. A first end of the frothing chamber 204 is directly coupled to the mixing chamber 202 and has a first diameter substantially the same as the diameter of the mixing chamber 202. The diameter of the frothing chamber 204 increases along the length of the frothing chamber 204 such that a second end of the frothing chamber 204 has a second diameter that is greater than the first diameter. As previously noted, ozone or air has been dissolved into the water in the pressure vessel 144. The gradual increase in diameter of the frothing chamber 204 causes bubbles to form in the gaseous water. Contaminants in the water attach to the surfaces of the formed bubbles and the bubbles naturally rise to the top of the water to form a froth.

The water proceeds from the frothing chamber 204 to a separation chamber 206 directly coupled to the frothing chamber 204. The separation chamber 206 may have a cylindrical shape that has a diameter substantially the same as the diameter of the second end of the frothing chamber 204. As previously noted, froth including contaminants attached to surfaces of bubbles is formed on top of the water. In the separation chamber 206, the froth is skimmed off the top of the water. The separation chamber 206 includes a separation plate 208 to skim the froth off of the water. The separation plate 208 may be a plate that extends from a top of the separation chamber 206 down a portion of the height of the separation chamber 206 such that the separation plate 208 skims the froth off of the water while allowing the remainder of the water to pass through the separation chamber 206 unimpeded. The separation plate 208 is also structured to direct the froth to a discharge tube 210 attached to a top of the separation chamber 206. The discharge tube may be coupled to the waste treatment system 146 so that the discharged froth may be transported to the waste treatment system 146 for disposal.

The water proceeds from the separation chamber 206 to a degassing chamber 212 directly coupled to the separation chamber 206. The degassing chamber 212 includes a first stage that has a cylindrical shape with substantially the same diameter as the separation chamber 206. The degassing chamber also includes a second stage that has a first end with the same diameter as the first stage of the degassing chamber. The second stage of the degassing chamber 212 reduces in diameter gradually to a discharge port 220. The first stage of the degassing chamber 212 includes a first exit port 214 disposed at the top of the degassing chamber 212 which allows gasses to escape from the water and be collected for disposal or reuse. The second stage of the degassing chamber 212 includes a second exit port 218 disposed at the top of the degassing chamber 212 which also allows for gasses to be collected for disposal and reuse. The discharge port 220 is disposed lower on the degassing chamber 212 than the second exit port 218. The second stage of the degassing chamber 212 also includes a liquid diverting structure 216. The liquid diverting structure 216 is disposed between the second exit port 218 and the discharge port 220. The liquid diverting structure 216 extends downward into the degassing chamber 212 such that a bottom of the liquid diverting structure 216 is below a bottom of the discharge port 220. The liquid diverting structure 216 is structured such that water traveling to the discharge port 220 must travel below the bottom of the liquid diverting structure 216 and then up to the discharge port 220. This type of structure prevents gasses from reaching the discharge port 220. Instead, gasses rise above the liquid diverting structure 216 and are collected by the first or second exit ports 214,218 that are disposed as the top of the degassing chamber 212.

Referring back to FIG. 1, froth and gasses collected by the frothing cell 200 may be transported to the waste treatment system 146 for disposal, or may be transported elsewhere for reuse. The water discharged from the discharge port 220 of the frothing cell 200 has reduced contaminants as a result of the frothing cell 200 and is transported from the frothing cell 200 to a collection tank 148. In the collection tank 148, any air or ozone remaining in the water may be safely vented to atmosphere.

Water in the collection tank 148 is pumped by a pump 150 to a filtration system 152. The filtration system 152 is structured to remove any solid contaminants that were too heavy to be floated off in the frothing cell 200. To this extent, the filtration system 152 may include a membrane filter through which the water is passed to filter out any remaining solid contaminants.

From the collection tank 148, the water is transported to the first feed tank 102. The cleaned water introduced into the first feed tank 102 will displace the existing water in the first feed tank 102 causing the water level in the first feed tank 102 to rise. As the water level rises, the water on the top is skimmed off to the second feed tank 112 by the skimming trough 104, as previously described. The water at the top of the feed tanks 102,112,122,132 is more contaminated than water lower in the feed tanks 102,112,122,132. The multi-stage washer 100 has a continuous process of skimming water off of the top of the feed tanks 102, 112,122, 132, cleaning it with the water treatment system, and then reintroducing the cleaned water back into the first feed tank 102. This process reuses the water used to rinse cans thus reducing water usage. This process also cleans the water to remove contaminants and ensure that the cans being rinsed are not being rinsed with contaminated water. Thus, the multi-stage washer 100, including the water treatment system, efficiently and effectively rinses cans.

While FIG. 1 shows a particular arrangement of a portion of a multi-stage washer 100, it will be appreciated that variations may be made without departing from the scope of the disclosed concept. For example, the disclosed concept may be applied to any number of rinsing stages without departing from the scope of the disclosed concept. As an additional example, any number of feed tanks may be employed without departing from the scope of the disclosed concept. While these are two examples of variations that may be made without departing from the scope of the disclosed concept, it will be appreciated that other variations may also be made without departing from the scope of the disclosed concept.

While specific embodiments of the invention have been described in detail, it will be appreciated by those skilled in the art that various modifications and alternatives to those details could be developed in light of the overall teachings of the disclosure.

Accordingly, the particular arrangements disclosed are meant to be illustrative only and not limiting as to the scope of disclosed concept which is to be given the full breadth of the claims appended and any and all equivalents thereof.

What is claimed is:

1. A multi-stage can washer comprising:
a conveyor system structured to transport cans through the multi-stage can washer;
a piping system structured to transport water to a number of nozzles structured to spray the water onto cans being transported by the conveyor system;
one or more feed tanks structured to provide water to the piping system and to collect water sprayed by the nozzles, each feed tank including a skimming trough structured to skim water from a top portion of the feed tank; and
a water treatment system structured to receive contaminated water from the skimming trough corresponding to a last one of the one or more feed tanks, to clean the contaminated water, and to provide the cleaned water to a first one of the one or more feed tanks, the water treatment system including:
a pressure vessel structured to mix ozone or air with the contaminated water to create gaseous water;
a frothing cell structured to cause bubbles to form in the gaseous water to form a froth, to skim off and dispose of the froth, to degas the gaseous water to remove remaining gases, and to output degassed water; and
a filtration system structured to receive the degassed water, to filter solid particles from the degassed water to form cleaned water, and to provide the cleaned water to a first one of the one or more feed tanks.

2. The multi-stage can washer of claim 1, wherein the pressure vessel is structured to mix ozone with the contaminated water.

3. The multi-stage washer of claim 1, wherein the skimming trough is disposed at the top portion of the corresponding feed tank, and wherein the piping system is coupled to and structured to receive water from lower portions of the feed tanks.

4. The multi-stage washer of claim 1, wherein the frothing cell includes:
a frothing chamber having a gradually increasing diameter structured to form bubbles in the gaseous water to form froth;
a separation chamber coupled to the frothing chamber and having a separation plate disposed at a top portion of the separation chamber and structured to skim the froth off of the gaseous water; and
a degassing chamber structured to remove gasses from the gaseous water and to output degassed water, the degassing chamber including a liquid diverting structure structured to prevent gasses from reaching a discharge port.

5. The multi-stage washer of claim 4, wherein the frothing cell includes:
a mixing chamber structured to receive gaseous water from the pressure vessel and to mix one or more chemicals into the gaseous water.

6. The multi-stage washer of claim 5, wherein the mixing chamber has a cylindrical shape having a diameter substantially the same as a smallest diameter of the frothing chamber, and wherein the mixing chamber is directly coupled to the frothing chamber and structured to provide the gaseous water to the frothing chamber.

7. The multi-stage washer of claim 4, wherein the separation chamber has a cylindrical shape having a diameter substantially the same as a largest diameter of the frothing chamber.

8. The multi-stage washer of claim 4, wherein the separation plate extends from the top portion of the separation chamber and is structured to skim the froth off of the gaseous water and allow a remainder of the gaseous water to proceed to the degassing chamber.

9. The multi-stage washer of claim 8, wherein a discharge tube is coupled to the separation chamber, and wherein the separation plate is structured to direct the froth to the discharge tube.

10. The multi-stage washer of claim 4, wherein the degassing chamber includes a first stage having a cylindrical shape having a diameter substantially the same as a largest diameter of the frothing chamber, and wherein the degassing chamber includes a second stage directly coupled to the first stage, the second stage having a gradually decreasing diameter.

11. The multi-stage washer of claim 10, wherein the second stage of the degassing chamber includes at least one exit port disposed at a top portion of the second stage of the degassing chamber and structured to allow gasses to escape from the second stage of the degassing chamber, and wherein a lower portion of the second stage of the degassing chamber is coupled to the discharge port.

12. A water treatment system for a multi-stage can washer, the water treatment system comprising:
a pressure vessel structured to receive contaminated water and to mix ozone or air with the contaminated water to create gaseous water;
a frothing cell structured to cause bubbles to form in the gaseous water to form a froth, to skim off and dispose of the froth, to degas the gaseous water to remove remaining gases, and to output degassed water; and
a filtration system structured to receive the degassed water, to filter solid particles from the degassed water to form cleaned water, and to output the cleaned water.

13. The water treatment system of claim 12, wherein the frothing cell includes:
a frothing chamber having a gradually increasing diameter structured to form bubbles in the gaseous water to form froth;
a separation chamber coupled to the frothing chamber and having a separation plate disposed at a top portion of the separation chamber and structured to skim the froth off of the gaseous water; and
a degassing chamber structured to remove gasses from the gaseous water and to output degassed water, the degassing chamber including a liquid diverting structure structured to prevent gasses from reaching a discharge port.

14. The water treatment system of claim 12, wherein the frothing cell includes:
a mixing chamber structured to receive gaseous water from the pressure vessel and to mix one or more chemicals into the gaseous water,
wherein the mixing chamber has a cylindrical shape having a diameter substantially the same as a smallest diameter of the frothing chamber, and wherein the mixing chamber is directly coupled to the frothing chamber and structured to provide the gaseous water to the frothing chamber.

15. The water treatment system of claim 12, wherein the separation chamber has a cylindrical shape having a diameter substantially the same as a largest diameter of the frothing chamber, and
wherein the separation plate extends from the top portion of the separation chamber and is structured to skim the froth off of the gaseous water and allow a remainder of the gaseous water to proceed to the degassing chamber,
wherein a discharge tube is coupled to the separation chamber, and
wherein the separation plate is structured to direct the froth to the discharge tube.

16. The water treatment system of claim 12, wherein the degassing chamber includes a first stage having a cylindrical shape having a diameter substantially the same as a largest diameter of the frothing chamber,
wherein the degassing chamber includes a second stage directly coupled to the first stage, the second stage having a gradually decreasing diameter,
wherein the second stage of the degassing chamber includes at least one exit port disposed at a top portion of the second stage of the degassing chamber and structured to allow gasses to escape from the second stage of the degassing chamber, and
wherein a lower portion of the second stage of the degassing chamber is coupled to the discharge port.

17. A frothing cell for a water treatment system for a multi-stage can washer, the frothing cell comprising:
a frothing chamber having a gradually increasing diameter structured to form bubbles in the gaseous water to form froth;
a separation chamber coupled to the frothing chamber and having a separation plate disposed at a top portion of the separation chamber and structured to skim the froth off of the gaseous water; and
a degassing chamber structured to remove gasses from the gaseous water and to output degassed water, the degassing chamber including a liquid diverting structure structured to prevent gasses from reaching a discharge port.

18. The frothing cell of claim 17, wherein the frothing cell includes:
a mixing chamber structured to receive gaseous water from the pressure vessel and to mix one or more chemicals into the gaseous water,
wherein the mixing chamber has a cylindrical shape having a diameter substantially the same as a smallest diameter of the frothing chamber, and wherein the mixing chamber is directly coupled to the frothing chamber and structured to provide the gaseous water to the frothing chamber.

19. The frothing cell of claim 17, wherein the separation chamber has a cylindrical shape having a diameter substantially the same as a largest diameter of the frothing chamber, and
wherein the separation plate extends from the top portion of the separation chamber and is structured to skim the froth off of the gaseous water and allow a remainder of the gaseous water to proceed to the degassing chamber,
wherein a discharge tube is coupled to the separation chamber, and
wherein the separation plate is structured to direct the froth to the discharge tube.

20. The frothing cell of claim 17, wherein the degassing chamber includes a first stage having a cylindrical shape having a diameter substantially the same as a largest diameter of the frothing chamber,
wherein the degassing chamber includes a second stage directly coupled to the first stage, the second stage having a gradually decreasing diameter,
wherein the second stage of the degassing chamber includes at least one exit port disposed at a top portion of the second stage of the degassing chamber and structured to allow gasses to escape from the second stage of the degassing chamber, and
wherein a lower portion of the second stage of the degassing chamber is coupled to the discharge port.
